(19) United States
(12) Patent Application Publication
(10) Pub. No.: US 2007/0111168 A1
(43) Pub. Date: May 17, 2007

(54) In the invention is offered a toothbrush, improved, that offers an incorporate lamp, or led, and mirror in its header both in the opposite side of the bristles, which optimizes oral hygiene and dental verification

(76) Inventor: L. Claudio Ribal, Santiago (CL)

Correspondence Address: Ms. Pilar Ribal, P. O. Box 37503, San Juan, PR, 00937, US

(21) Appl. No.: 11/526,236

(22) Filed: Sep. 25, 2006

Related U.S. Application Data
(60) Provisional application No. 60/720,336, filed on Sep. 26, 2005.

(51) Int. Cl. A61C 15/00

(52) U.S. Cl. 433/216

(57) ABSTRACT

Toothbrush for oral hygiene and dental verification, one that offers an incorporated lamp and mirror at the same time in its structure. The finished structure of the toothbrush, to the far end and opposed side of bristles in the head, will accommodates a mirror and a lamp that it is connected to an electric circuit inside of structure of the handle, connecting to the power source, and that provided by a switch will turn on and off the indicated lamp. When the lamp is turned on its light will allow verify the state of dentures and oral cavity, also permitting the user to verify by luminescence transparency and contrast the individual state of each tooth and with the mirror, the inner side of each dental piece, allowing you the prompt opportunity to prevent the formation of plaque, cavities and check the state of your gums

In present times toothbrushes are structured by a long handle, being one of its far ends the main head which guests the cleaning brush or bristles. Every given day the tooth brush user does the brushing task and does not have any other alternative that allows him/her to do an appropriate check of the state of his/her oral hygiene and denture condition, only the vision check, due to an occasional soreness or ache, that is performed inappropriately in front of a mirror with inappropriate lighting. On those cases, generally the affliction or damage has developed sufficiently to the point that a prevention action has been surpassed and a dentist intervention is required.

Nowadays, the different models of toothbrushes are built with different shapes to the head to improve the hygiene performance; also they incorporate discoloration of the bristles that indicates the peak performance of the toothbrush has come to an end. There are also some with part of its handle flexible making them more accessible to some oral areas. The bristles come with different thickness and with and shape to have different effects, in some cases the bristles come altogether and in different angles to clean your teeth and massage your gums at the same time. Some tooth brushes nowadays even come with an electrical motor that produce rotating movements to a group or bristles.

All this application are focused only to the structure and formation of the tooth brush, and they omit certain kind of activities and control that the user should have, that are determined activities and permit the user to take action as the result of a detailed and periodic observation.

The present invention offers an improved toothbrush, which optimizes oral hygiene and dental verification, one that offers an incorporated lamp, or led, and mirror at the same time in its structure, in is head, and in the opposite side of the bristles. When the lamp is turned on its light will allow you to verify the state of your dentures and your oral cavity, also permitting the user to verify by luminescence transparency and contrast the individual state of each tooth and with the mirror, the inner side of each dental piece, allowing you the prompt opportunity to prevent the formation of plaque, cavities and check the state of your gums.

The improved toothbrush use the best technology and does not physically affect in any way your oral cavity, incorporated by an exterior cylinder that accommodates and interior one.

The exterior cylinder incorporates on the far side of his inner structure, in a bas-relief, on the opposite side of the bristles, a mirror of the same dimension of the bas-relief therefore there will be no edges, this same cylinder on his opposite side incorporates an opening with an interior screw followed by a screwed ledge that permits the adjusted introduction of the internal cylinder, its opposite part ends in a circular centered opening. The internal cylinder its incorporated by a larger segment, that has a smaller diameter than the external one, only towards its middle part which afterwards thins abruptly, following into a tubular segment with a smaller diameter all to its far end that reckons with a centered circular opening. The far side of the internal cylinder has an opening in witch a battery is inserted and rests in a metallic segment that is fixated to the base of the main part that it is of a larger diameter, this metallic segment is connected to a cable that connects to a lamp that it is inserted into the circular centered opening of the smaller tubular portion, connected also to the lamp a second cable extends trough the smaller tubular portion into the larger one utilizing the smallest part of the diameter of the metallic segment fixated to the base of the larger part and continuing to the terminal opening of the interior cylinder in witch is anchored to a partial edge of the opening of the of the internal cylinder. The internal cylinder is introduced into the external one thought the far side opening until the small tubular end of the internal cylinder fits together with the centered circular opening of the external cylinder, at that moment the far side of the internal cylinder is tight and immobilized by the internal ring of the far side of the external cylinder, avoiding it to slide. By doing so, the lamp remains crowning the external far side of the item, this is obtained by passing though the centered circular opening of both cylinders.

To close the openings of both cylinders a cap is screwed on to the internal annular segment, which includes an external screw top, this cap is occupied transversally by an elongated cylindered body that stands out on both sides of the cap. The part that elongates to the interior of the item finishes on a metallic segment that when you finish screwing on it lies on top of the battery, that metallic portion has an elongation which connects and disconnects with the metallic portion that is located on the partial edge of the interior cylinder closing the electric circuit which activates the lamp.

This allows the user, once the lamp is on to see and check his/her oral cavity on detail and by transparency and translucency of the teeth, by positioning the lamp behind the teeth one can verify the existence of shadows, formation or accumulation of plaque or cavities on your teeth as well as in your gums.

By using the mirror, located at the opposite side of the bristles, one can verify the state of the inner side of the teeth by illuminating with the lamp.

To better explain this invention, a description will be made with the following figures:

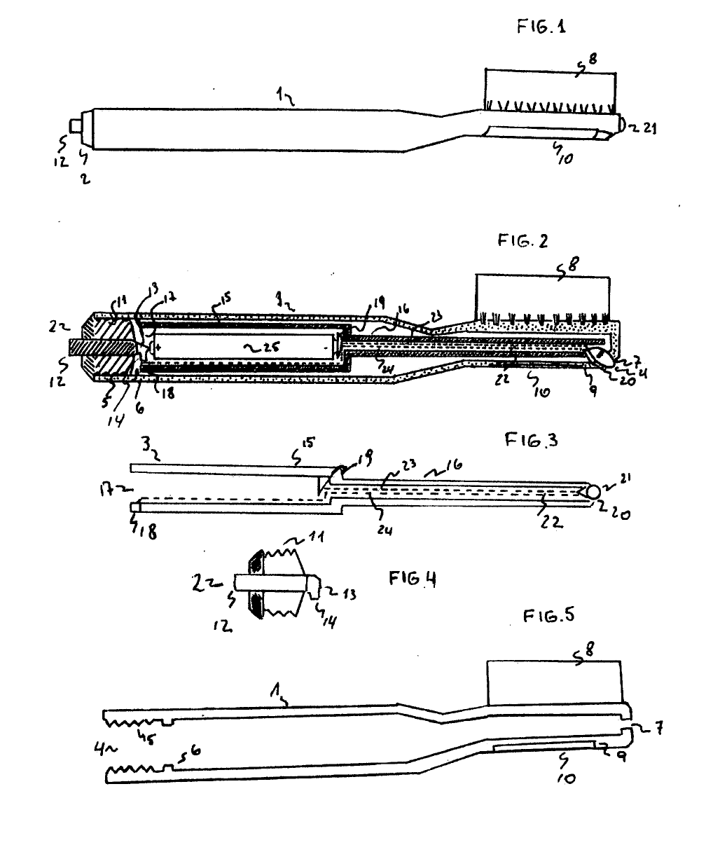

FIG. 1 Show a general view of the device in its function stage.

FIG. 2 Show a amplified view of the axial slice of the Invention, in detail.

FIG. 3.Show a detailed view of the electrical circuit located on its interior.

FIG. 4 Show a detailed view of the incorporated switch in the cap or on the handle of the item.

FIG. 5 Show a view of the axial slice of the device without its other components.

As you can appreciate in FIGS. 1 through 5, this Invention consists of a hygiene device which is an improved toothbrush and dental verification device which has 3 different parts.

The main body part 1, (see FIG. 5.) which is the handle and the bristles, is rounded and interior, and it posses in its far side an opening 4 with inner screw rails 5 and a annular interior ledge 6, in its other side it has closed centered circular opening lateral 7, in angle of 20 to 30 degree, ahead of the position of mirror 10, the exterior is crowned by the cleaning bristles 8 and on the opposing surface of the bristles a bas-relief 9 in with a mirror is inserted 10.

The other body part 2, (see FIG. 4) is the Cap of the main body part 1, it possesses a annular screwed extension 11 and it is transversally occupied by the switch 12 which its far side is formed by a metallic segment 13 with a lateral elongation 14 The body part 3, (see FIG. 3) consists of a cylinder with a smaller diameter than body 1, composed by an wide section 15 and other section with a reduced diameter, thinner, 16. Its far side possesses an opening 17 in which its interior ledge a metallic segment is inserted. 18, in the base of the section 15 a metallic body is inserted 19 in which the part with the smaller diameter is the interior of the larger cylinder section. 15. The thinner section 16 has on its far end side a circular opening 20 in which a lamp is inserted 21 which is connected to an electrical circuit 22, in which cable 23 is connected to the metallic body 19 and cable 24 is connected to metallic segment 18.

Therefore, (see FIG. 2) in order to connect all the composing elements of the device, the body part 3 is axially introduced into element 1 into the opening 4 in which the far end 16 with the lamp 21 surpasses opening 7 leaving it fixed by pressure while the far end of section 15 is immobilized by the annular ledge 6. Immediately the battery is ins erted 25 sliding it through opening 4 at the same time passing through opening 17 of body part 3 until its negative pole (−) lays on the metallic body 1, afterwards, one screws on cap 2 to extension 11 with a cap screw of body 1 at the moment that section 11 inserts in section 12 laying on the positive pole (+) of battery 25

To turn on the lamp 21, the extension 12 is turned in a way that its lateral extension 14 makes contact with section 18 of body 3. By doing the inverse procedure the lamp is turned off.

1. Toothbrush for enhanced hygiene and dental verification, one with a hollow cylindrical handle with a screwed on cap, that houses in its interior a battery that feeds a tiny light bulb in the opposite side of the handle, CHARACTERIZED because in the opposite side of the bristles it has incorporated a tiny light bulb, or led, and a mirror that its inserted in a depression that does not allow edges, and because the cylindrical box is composed of two portions, the first back portion of a larger diameter with its back side open that allows the insertion of the battery and its provide by a metallic segment on the interior edge of his external opening, that works as the first electrical contact and a metallic segment of smaller diameter that acts as the second contact on the opposite extremity and a second forward cylindrical portion of a smaller diameter in witch end a tiny light bulb its inserted with comes out in a intermediate position with respect of the bristles and the insertion surface of the mirror, extending inside the before mentioned tubular box two electrical cables, a larger one that connects the bulb to the first metal segment and passes trough the internal edge of the subsequent portion and a shorter one that connects the bulb to the second metal segment, turning on and off the before mentioned bulb with a switch inserted on the cap, that has a central extension with a lateral flick, that when the cap is screwed on connects respectably with the positive pole of the battery and with the first metal segment, closing the circuit, with its deactivated by unscrewing the cap.
